(19) United States
(12) Patent Application Publication
(10) Pub. No.: US 2021/0271699 A1
(43) Pub. Date: Sep. 2, 2021

(54) Techniques for Searching a Database of Documents by Analogy

(71) Applicant: The Regents of the University of California, Oakland, CA (US)

(72) Inventor: Adam M. Smith, Santa Cruz, CA (US)

(21) Appl. No.: 17/258,270

(22) PCT Filed: Jul. 8, 2019
(86) PCT No.: PCT/US19/40824

§ 371 Date: Jan. 6, 2021

Related U.S. Application Data
(60) Provisional application No. 62/694,680, filed on Jul. 6, 2018.

(51) Int. Cl. G06F 16/33; G06F 16/31; G06N 3/08

(52) U.S. Cl. CPC G06F 16/3347; G06N 3/08; G06F 16/316

(57) ABSTRACT

Document retrieval techniques include storing in an index for each archived document a vector of dimension N, based on a query portion of the document and a particular algorithm. An analogy query is received from a requester, indicating a query portion A, a query portion B and a query portion C, each of one or more documents, so that each retrieved document D has a query portion D that is related to C as B is related to A. Vectors A, B and C are determined each based on its query portion and the particular algorithm. A transform from vector A to vector B is determined. An enhanced vector Q is based on the vector C and the transform. Each retrieved document D is based on proximity of a vector of each in the index to the enhanced vector Q; and at least a reference is presented to the requester.

### CROSS-REFERENCE TO RELATED APPLICATION

This application claims benefit under 35 U.S.C. § 119(e) of Provisional Appln. 62/694,680, filed Jul. 6, 2018, the entire contents of which is hereby incorporated by reference as if fully set forth herein.

### BACKGROUND

As used herein a document refers to any material in a digital form including text, audio clips, images, or any other digital data in any format, including contents of computer registers and other portions of memory, with time or spatial stamps or other metadata or reference to locations within a larger document including as specific pages, lines, frames, and moments alone or in any combination.

Artificial intelligence (AI) and information retrieval (IR) have a long and entangled past. AI powers multiple facets of commercial web search engines like Google, Baidu, and Yandex. Although these services are primarily designed to retrieve hypertext documents based on textual queries, they are increasingly growing into the domains of visual search (using images as queries). Visual search can involve sophisticated automated understanding of image and video content. Usually, a user must specify examples of content to be found in a retrieved document.

### SUMMARY

In some circumstances, it is difficult for a user to adequately express the content desired. It is recognized here that such users could be greatly assisted by expressing the desired content in terms of analogy with one or more pairs of other documents available to the user. Therefore, techniques are provided for guiding search and retrieval of documents based on analogy with a pair of other documents. In the following, the user or requester is a human or a separate automated process.

In a first set of embodiments, a method for retrieval of a document includes storing in an index for each document from an archived set of documents, a vector of dimension N. The vector is based on a query portion of the document according to a particular algorithm. The method also includes receiving, from a requester, an analogy query that indicates a query portion A based on a first set of one or more documents and a query portion B based on a second set of one or more documents and a query portion C of a third set of one or more documents. The analogy query describes a result such that each of one or more retrieved documents D has a query portion D that is related to query portion C as query portion B is related to query portion A. The method further includes determining a vector A based on the query portion A and the particular algorithm, a vector B based on the query portion B and the particular algorithm, and a vector C based on the query portion C and the particular algorithm. Still further, the method includes determining a transform from vector A to vector B; and, forming an enhanced vector Q based on the vector C and the transform from vector A to vector B. Even further still, the method includes presenting, to the requester, at least a reference to, or a portion of, each of one or more retrieved documents D from the archived set of documents based on proximity of a vector of each of the one or more retrieved documents D in the index to the enhanced vector Q.

In a second set of embodiments, a method implemented on a processor for retrieval of a document, includes storing an archived set of documents; and, receiving, from a requester, a query. The method further includes, based on the query, identifying a plurality of retrieved documents D from the archived set of documents. The method still further includes presenting, to the requester, at least a reference to, or a portion of, each of the plurality of retrieved documents D on a two-dimension plot. A first dimension of the two dimensional plot indicates similarity to a first portion of the query and a second dimension of the two dimensional plot indicates similarity to a different second portion of the query.

In other sets of embodiments, a non-transitory computer-readable medium or an apparatus is configured to perform one or more steps of one or more of the above methods.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 is a block diagram that illustrates an example processing system configured to perform analogy retrieval of documents, according to an embodiment;

FIG. 2A and FIG. 2B are block diagrams that illustrates an example documents database and an index database, respectively, according to an embodiment;

FIG. 3A is a flow diagram that illustrates an example method for forming an index used in an analogy retrieval system, according to an embodiment;

FIG. 3B is a flow diagram that illustrates an example method for an analogy retrieval system, according to an embodiment;

FIG. 4A and FIG. 4B are block diagrams that illustrate example input screens for an analogy query, according to an embodiment;

FIG. 5A through FIG. 5D are images that illustrate an example of analogy retrieval of moments in an interactive media stream, according to an embodiment;

FIG. 6A is a block diagram that illustrates an example vector transform and enhancement for an analogy retrieval, according to an embodiment;

FIG. 6B and FIG. 6C are plots that illustrate example input screen for user selection of analogy, according to various embodiments;

FIG. 7 is a plot that illustrates an example trace of a similarity measure with moments in an interactive media stream with and without using an analogy vector transform, according to an embodiment;

FIG. 8A through FIG. 8D are images that illustrate one example of analogy retrieval of moments in an interactive media stream, according to an embodiment;

FIG. 9A and FIG. 9B are plots that illustrate other example traces of a similarity measure with moments in an interactive media stream with and without using an analogy vector transform, according to an embodiment;

FIG. 10A through FIG. 10D are images that illustrate an example of analogy retrieval of moments in an interactive media stream, according to an embodiment;

FIG. 11 is a plot that illustrates example traces of a similarity measure with moments in an interactive media stream using an analogy vector transform with various scale factors k, according to an embodiment;

FIG. 12 is a block diagram that illustrates an example neural network used in the pixels-to-memory proxy task for generating embedding vectors, according to an embodiment;

FIG. 13A and FIG. 13B are scatter plot that illustrate an example tSNE visualization of embedding vectors, according to an embodiment;

FIG. 14 is a block diagram that illustrates an example of compressed tree representation, according to an embodiment;

FIG. 15 is a block diagram that illustrates a computer system upon which an embodiment of the invention may be implemented;

FIG. 16 illustrates a chip set upon which an embodiment of the invention may be implemented; and

FIG. 17 is a diagram of exemplary components of a mobile terminal (e.g., cell phone handset) for communications, which is capable of operating in the system, according to one embodiment.

### DETAILED DESCRIPTION

A method and apparatus are described for guiding search and retrieval of documents based on analogy with a pair of other documents or portions thereof. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5× to 2×, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of querying a collection of interactive multimedia moments using a single base query portion consisting of a screenshot and a simple analogy using two other screenshots. However, the invention is not limited to this context. In other embodiments the collection is of other documents of single or multiple media, (including without limitation text, images, audio clips, video clips, portions of digital memory, alone or in any combination), at one or more times or spatial locations, in one or more databases on one or more different equipment on a private or public network. In other embodiments, the query portion is different from a screenshot, e.g., made up of a portion of a screen shot, including all or a portion of text, or audio, or a memory map or multiple instances of each. In other embodiments, each of one or more of the base query and the pair demonstrating the analogy or some combination is made up of a combination of two or more query portions averaged or otherwise combined.

### 1. STRUCTURAL OVERVIEW

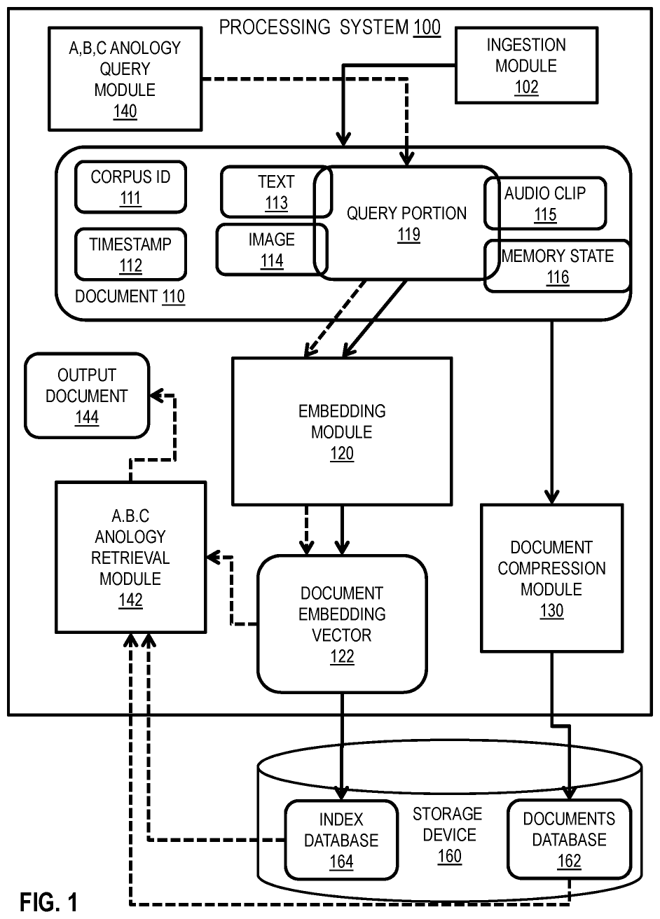

A method and apparatus are described for guiding search and retrieval of documents based on analogy with a pair of other documents or portions thereof. FIG. 1 is a block diagram that illustrates an example processing system 100 configured to perform analogy retrieval of documents, according to an embodiment. The system operates on documents, such as document 110. A document 110 comprises one or more of text 113, images 114, audio clips 115 and maps of memory state 116 and other forms of media (not shown) and a time or location stamp 112 or any other metadata in any combination. Documents of different types form different collections, each collection is called a corpus and has a corpus ID that is either internally (shown as field 111) or externally associated with a document 110. The system 100 operates on multiple documents in a corpus, collected by an ingestion module 102, such as a web crawler or simulation, or provided by a user/requester through analogy input module 140; but, for purposes of illustration, a single document 110 of the corpus or query is shown in FIG. 1.

For any document in a corpus, a particular portion of the document called a query portion 119 is used for purposes of processing analogy queries. In some embodiment, the query portion 119 is the whole document 110; but, in general the query portion 119 is a subset of the document that is of special interest or especially useful or easily provided by requestors, such as just the text of a multimedia document, or an MPEG base image of multiple images in a video clip, or a five second introduction of an audio clip, or memory locations for certain parameters (e.g., score, character strength, character size, character treasures or weapons in a videogame), or some combination.

The embedding module 120 is configured to produce a document embedding vector 122 (simply called vector 122 hereinafter) of dimension N from the query portion 119 of each document 110 in the corpus. That is, the embedding module 120 maps the document 110 to a vector 122. In some embodiments, the dimension N of the vector is much less than a size S of the document, which offers the advantage of more efficient operations. However, a great advantage of having the vector depend on the query portion, rather than the whole document, is that a query portion can be selected which is considered more relevant for searching purposes. For example, characters present and percentage of colors in an image rather than detailed pixel arrangement. Thus the more similar the query portions of two documents, the closer are the resulting vectors in their vector space. This can occur even if the documents outside the query portions are very different. In some embodiments, it is valuable to include some of the metadata in the query portion. In some embodiments described in the examples section, using deep training neural networks, the vector is not only derived from the query portion but is also predictive of other portions of the document (the memory map). In these embodiments, the vectors reflect more than the query portion.

Any method may be used to generate the vector from the query portion 119 of the document 110. In some embodiments, the vector 122 is produced by N different functions of the query portion, such as N different statistical functions including histograms or various moments of a distribution of values in the query portion. In some embodiments, basis functions are defined for the corpus of query portions, such as orthogonal basis functions like Fourier components or wavelets or principal components. In these embodiments, the embedding module 120 determines the amplitudes for these basis functions, and the set of amplitudes constitute the vector 122. In some embodiments, such as the deep training neural network the embedding module 120 is designed so that the vector 122 produced is predictive not only of the query portion but of other features of the document 110. To check if an embedding has the property that vector proximity indicates relevance, experiments can be performed. For example, a collection of items that should form the analogy A:B::C:D are assembled. Each item in the collection is embedded to a vector and linear algebra is used to construct the transform, e.g., Q=C+B−A. Then, it is determined how similar Q is to D. This similarity is averaged over the whole collection. The embeddings that produce the greater similarity are given better scores and favored over other embeddings.

The vectors 122 of the documents 110 collected by the ingestion module 102 are stored as an index in one or more files on a local or distributed database called an index database 164 on one or more storage devices 160. The index associates each vector 122 with the corresponding document 110 using a document ID that can be used to determine where or how the document was collected by the ingestion module. In some embodiments, the documents are also stored in a document database 162 on one or more storage devices 160 in one or more local or distributed databases. In some embodiments, the document is first compressed using any known lossy or lossless compression algorithms in document compression module 130 before being stored in document database 162.

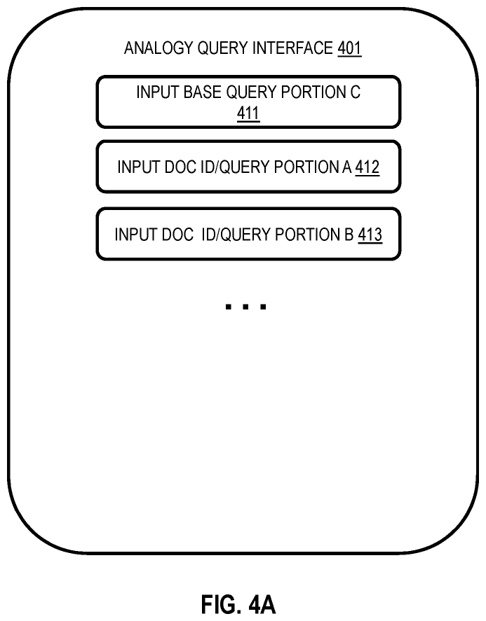

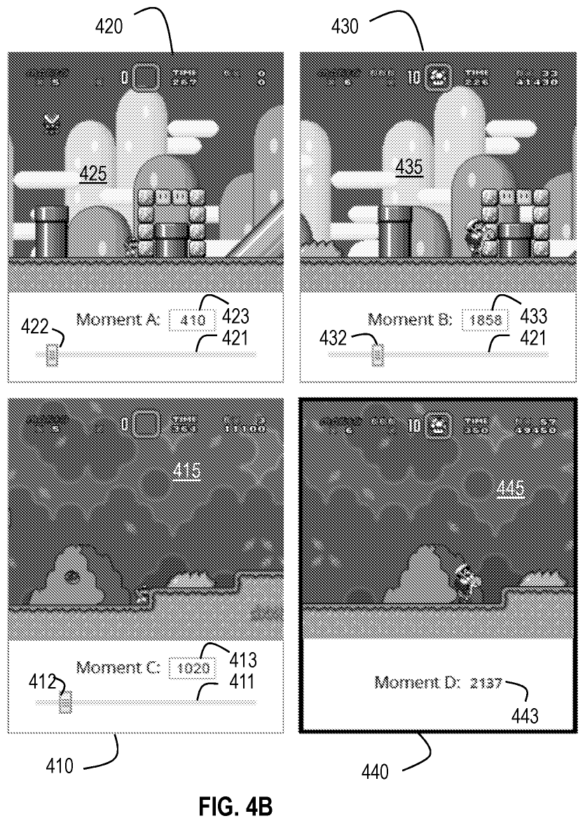

The processing system 100 also includes modules to retrieve one or more documents from the document database or other source of the documents using an analogy. The basic form of the analogy query is that a document D is to be retrieved that is related to a base document C as document A is related to document B. More precisely using the terms defined above, each of one or more retrieved documents D has a query portion D (P_{D}) that is related to query portion C (P_{C}) as query portion B (P_{B}) is related to query portion A (P_{A}). Thus analogy query module 140 is configured to allow a requestor, such as a human or some separate automated process, to specify at least the query portion of base document C and the query portions of analogy pair documents A and B. For example, user interface as described below with reference to FIG. 4A and FIG. 4B is presented to a requester, e.g., as an input screed to a human or as an application programming interface (API) to an automatic process. Only the query portion, e.g., the title text or screenshot, of P_{C}, P_{A} and P_{B} need be specified, so there need not even be a full document for C or A or B in the corpus or elsewhere. Thus the output of the query module 140 is indicated by a dashed arrow leading to the query portion 119 of a document for each of A and B and C. However, either A or B or C or some combination can be derived from documents in the corpus. In some embodiments, the query portions of either A or B or C or some combination is an amalgam of several query portions, e.g., a pixel or other metric average or minimum or maximum of multiple screenshots. The query module 140 is configured to combine the multiple query portions for each of A or B or C.

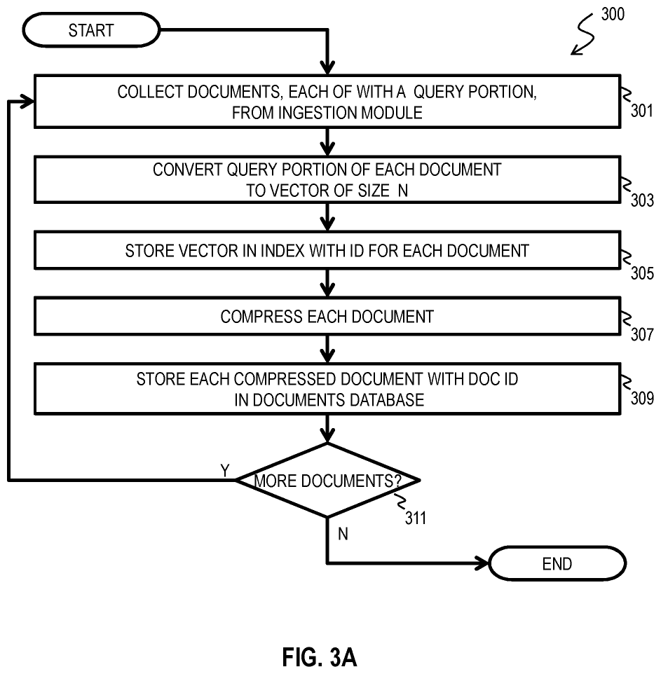

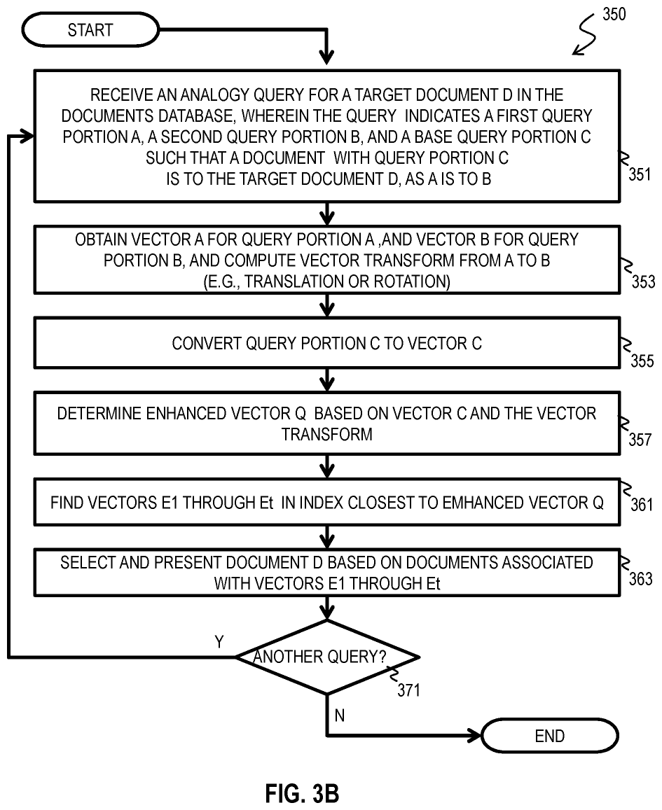

In the processing system 100 the same embedding module 120 is used to produce vectors 122 for A and B and C, designated V_{A}, V_{B}, V_{C}, respectively, as indicated by the dashed arrows leading into and out of the embedding module 120. These vectors are input, as indicated by the dashed arrow leading from the embedded vector 122, into an analogy retrieval module 142 that is configured to find one or more documents in the documents database 162 that satisfies the analogy query. A method for using these vectors to produce one or more output documents 144 is described below with reference to FIG. 3B. The method uses the index database 164 as indicated by the dashed arrow from the index database to the retrieval module 142. The output documents 144 are then returned to the requestor through the same or different interface used for accepting the analogy query. In some embodiments, the one or more output documents are retrieved from the documents database 162, as indicated by the dashed arrow from documents database 162 to retrieval module 142; and if compressed, the output documents are decompressed.

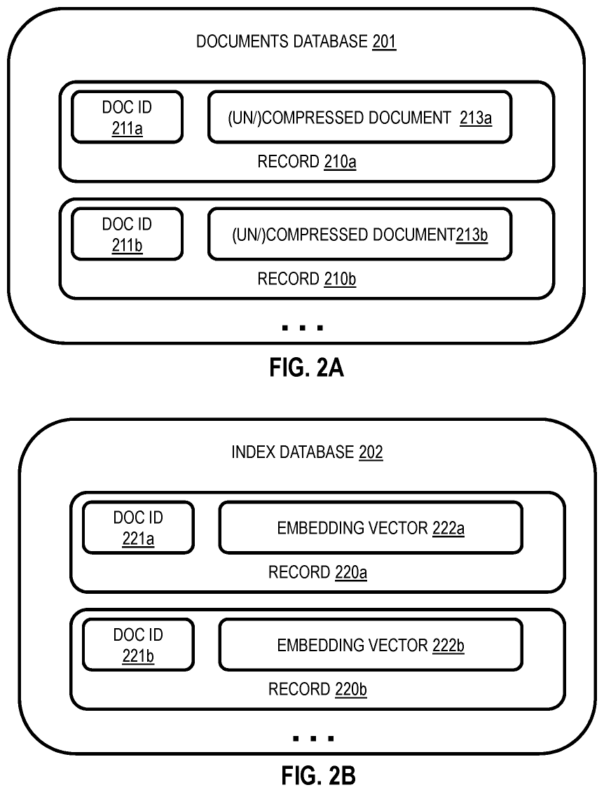

FIG. 2A and FIG. 2B are block diagrams that illustrates an example documents database and an example index database, respectively, according to an embodiment. The documents database 201 include a record for each document, such as records 210a, 210b among others indicated by ellipsis and collectively referenced as document records 210. Each document record 210 includes a document identification (DOC ID) field, such as 211a and 211b among others collectively referenced as DOC ID field 211. The DOC ID field holds data that uniquely indicates each document, e.g., with corpus ID and document timestamp or serial number. Each document record 210 also includes a document field, such as 213a and 213b among others collectively referenced as document field 213. The document field 213 holds data that can be used to reproduce the document in whole or in part, either by referring to another location on the network or by inclusion within the field in compressed or uncompressed form.

The index database 202 include a record for each document, such as records 220a, 220b among others indicated by ellipsis and collectively referenced as index records 220. Each index record 220 includes DOC ID field, such as 221a and 221b among others collectively referenced as DOC ID field 221. The DOC ID field holds data that corresponds to data in field 211 in documents database 201 records 210 so that a document associated with each index record can be identified and retrieved. Each index record 220 also includes an embedding vector field, such as 222a and 222b among others collectively referenced as embedding vector field 222. The embedding vector field 222 holds data that can be used to reproduce the embedding vector for the associated document, either by referring to another location on the network or by inclusion within the field in compressed or uncompressed form.

Although processes, equipment, and data structures are depicted in FIG. 1, FIG. 2A and FIG. 2B as integral blocks in a particular arrangement for purposes of illustration, in other embodiments one or more processes or data structures, or portions thereof, are arranged in a different manner, on the same or different hosts, in one or more databases, or are omitted, or one or more different processes or data structures are included on the same or different hosts. For example, an embedding vector filed 222 can be stored within each documents database record 210 rather than in an entirely separate file or database.

FIG. 4A and FIG. 4B are block diagrams that illustrate example input screens, according to an embodiment. In FIG. 4A, the interface 401 includes a field 411 to accept data that indicates at least a query portion for a base portion (P_{C}) and two fields 412 and 413 for analogy portions (P_{A} and P_{B}, respectively). If any of the portions are associated with a document in the corpus, the DOC ID can be used in the corresponding field 411, 412 or 413. If any of the portions is an amalgam of multiple portions, e.g., P_{C}=amalgam of P_{C1}, P_{C2} . . . , the corresponding field allows all those query portions, e.g., C1 and C2, to be entered. In some embodiments, the field 411, 412 or 413, or some combination, includes a pull-down menu to indicate how the multiple portions are to be amalgamated, e.g., by sum, by average or by some other method. In some embodiment's, the interface is an interface, such as a graphic user interface, for a human requester. In such embodiments, each of the fields 411, 412, 413 indicate one or more active areas on a screen. As is well known, an active area is a portion of a display to which a user can point using a pointing device (such as a cursor and cursor movement device, or a touch screen) to cause an action to be initiated by the device that includes the display. Well known forms of active areas are stand-alone buttons, radio buttons, check lists, pull down menus, scrolling lists, and text boxes, among others. Although areas, active areas, windows and tool bars are depicted in FIG. 4A as integral blocks in a particular arrangement on particular screens for purposes of illustration, in other embodiments, one or more screens, windows or active areas, or portions thereof, are arranged in a different order, are of different types, or one or more are omitted, or additional areas are included or the user interfaces are changed in some combination of ways.

For example, FIG. 4B illustrates an example GUI consisting of three input panes and one output pane for video documents, such as a recording of video game played or simulated. Each input pane depicts a frame from a video document, a slide bar, a slide on the slide bar, and a data field presenting the location or time stamp for the displayed frame within the video document. Pane 420 includes a video frame 425 that represents all or part of the first analogy query portion of a document (P_{A}), a slide bar 421 active area with a slide 422 manipulated by a user to select a particular frame within the document, and a data field 423 displaying the time stamp associated with the selected frame. Pane 430 includes a video frame 435 that represents all or part of the second analogy query portion of a document (P_{B}), a slide bar 431 active area with a slide 432 manipulated by a user to select a particular frame within the document, and a data field 433 displaying the time stamp associated with the selected frame. Pane 410 includes a video frame 415 that represents all or part of the base query portion of a document (P_{C}), a slide bar 411 active area with a slide 412 manipulated by a user to select a particular frame within the document, and a data field 413 displaying the time stamp associated with the selected frame. Thus, the query by analogy can be specified for a video document by a user at a GUI.

In the illustrated embodiment, the result of the query by analogy is output in frame 440 that includes a video frame 445 that represents all or part of the output query portion of a document (P_{D}) and a data field 443 displaying the document and time stamp associated with the output result from the query by analogy.

### 2. METHOD OVERVIEW

FIG. 3A is a flow diagram that illustrates an example method 300 for forming an index used in an analogy retrieval system, according to an embodiment. Although steps are depicted in FIG. 3A, and in subsequent flowchart FIG. 3B, as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

In step 301, one or more documents for a corpus are collected by ingestion module. The documents are in a certain format and include a query portion. The document can be obtained by crawling the web, capturing streaming data, capturing data during an interactive session, a simulation or by any other means known, alone or in any combination. In the example embodiments for interactive multimedia videogame moments, described below, the document is one moment several megabytes in size and includes a single screenshot as the query portion and a memory state map excluded from the query portion.

In step 303 the query portion (e.g. query portion 119) of the document (e.g., document 110) is mapped to an embedding vector (e.g., vector 122) of dimension N by the embedding module 120. Any vector mapping may be used, as described above. In the example embodiments for interactive multimedia videogame moments, described below, the vector has dimension 256 as the result of a deep training neural network, wherein the 256 element vector is predictive of the contents of the memory state map. In step 305, the vector is stored in the index database, e.g., in field 222 in association with a document ID in field 221.

In optional step 307 the document is compressed for efficient storage. In optional step 309, the compressed or uncompressed document is stored in a documents database 162 such as database 201. In other embodiments, the document can be retrieved or reproduced from some other source, and step 307 or step 309 or both are omitted.

In step 311 it is determined whether another one or more documents are to be ingested and indexed. For example, it is determined whether a continuation condition is satisfied. If so, control returns to step 301 and following. Otherwise, the process ends. In some embodiments, the ingestion process 300 proceeds without end conditions or in parallel with the retrieval process described next, or both.

FIG. 3B is a flow diagram that illustrates an example method 350 for an analogy retrieval system, according to an embodiment. In step 351, an analogy query is received at analogy query module 140. The analogy query includes data indicating one or more query portions to serve as base query C, such as data indicating one or more documents C1, C2 . . . from which query portions P_{C1}, P_{C2} . . . can be taken. Or the requestor provides directly data that indicates one or more query portions, such as one or more screenshots. If multiple base portions are indicated, they are combined as indicated by the amalgamation method by default or as selected to form P_{C}. The analogy query also includes data indicating two or more query portions to serve as the analogy portions P_{A} and P_{B}, such as data indicating one or more documents A1, A2 . . . from which query portions P_{A1}, P_{A2} . . . can be taken and data indicating one or more documents B1, B2 . . . from which query portions P_{B1}, P_{B2} . . . can be taken. Or the requestor provides directly data that indicates one or more query portions, such as one or more screenshots. If multiple analogy portions are indicated, they are combined as indicated by the amalgamation method by default or as selected to produce P_{A} and P_{B}.

In step 353, the embedding module 120 is used on the analogy portions P_{A} and P_{B} to produce analogy vectors V_{A} and V_{B}. Also, during step 353 the analogy retrieval module 142 determines a transformation to produce V_{B} from V_{A}, exactly or approximately. For example, a vector translation (e.g., vector difference) or rotation (rotation matrix) or other affine or non-affine transformation is determined using method well known in the art. In the example embodiments described below, a scaled vector difference=k(V_{B}−V_{A}) with scaling factor k is determined as the transform during step 353.

In step 355, the embedding module 120 is used on the base query portion P_{C} to produce base query vector V_{C}. In step 357, the analogy retrieval module 142 determines an enhanced vector V_{Q} based on transforming the base query vector V_{C} with the transform determined for the analogy vectors. In the example embodiments described below, the transform is a scaled translation as described by Equation 1 with scaling factor k.

V_{Q}=V_{C}+k(V_{B}−V_{A}) (1)

In step 361, the analogy retrieval module 142 finds in the index 164 one or more vectors E1, E2 . . . Et that are closest to enhanced vector V_{Q}, using any vector distance measure, such as L0, L1, L2 (Euclidean distance), among others known in the art. In some embodiments, the vectors E1, E2 . . . are ranked in order of increasing distance. The DOC IDs associated with the found vectors are retrieved, e.g., from the documents database 162 and in some embodiments, contents for the retrieved documents are used in the ranking.

In step 363 one or more documents are selected from the retrieved documents and presented to the requester, in whole, in part, or by reference, e.g., on a graphical user interface or in a digital file through the API used to submit the query. Any method may be used to select the one or more documents, including the closest one document, the closest T documents where T is a fixed number (e.g., 10), or all the documents having vectors within a predetermined distance D from the enhanced vector V_{Q}.

In step 371 it is determined whether there is another query to process. If so, control passes back to step 351. Otherwise the process ends.

### 3. EXAMPLE EMBODIMENTS

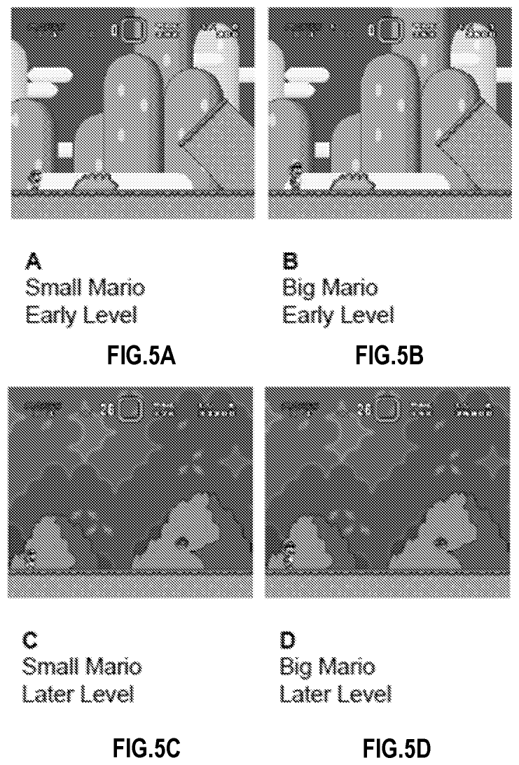

FIG. 5A through FIG. 5D are images that illustrate an example of analogy retrieval of moments in an interactive media stream, according to an embodiment. In this example, the interactive media stream is a videogame and the requestor is starting with a screenshot of a small character at a later level of the game, represented by FIG. 5C. The analogy is represented by screenshots from two moments earlier in the game, represented by FIG. 5A with a small character at an early level and FIG. 5B for the same level with a larger version of the character, and in the margins of the image there is text indicating more coin, a larger score and less time. FIG. 5D shows a manual selection of the best answer the system could provide to demonstrate the desired analogy. Compared to FIG. 5C, the game moment of FIG. 5D shows the same level (good), larger character (good), a fruit rattle, a minor score loss, and a time gain. The latter three factors do not follow the analogy very closely but are not considered important by the human selector.

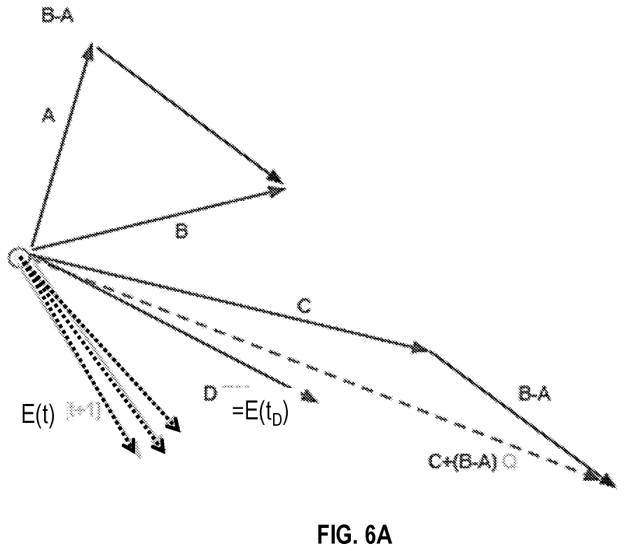

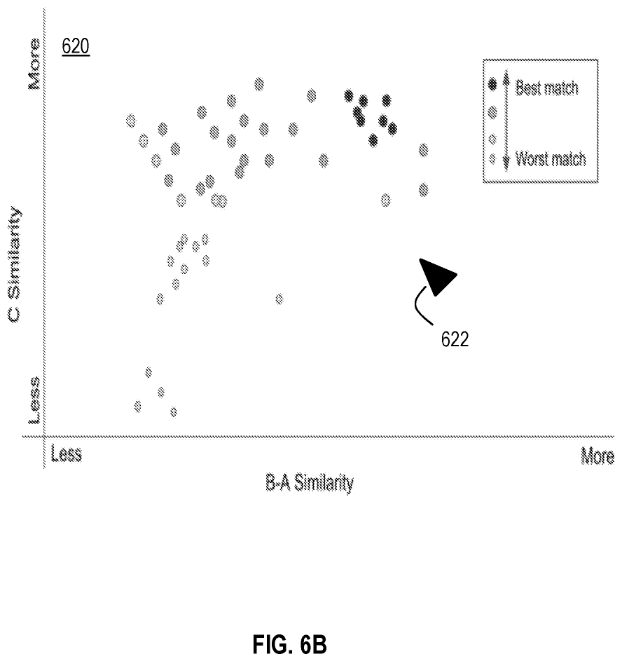

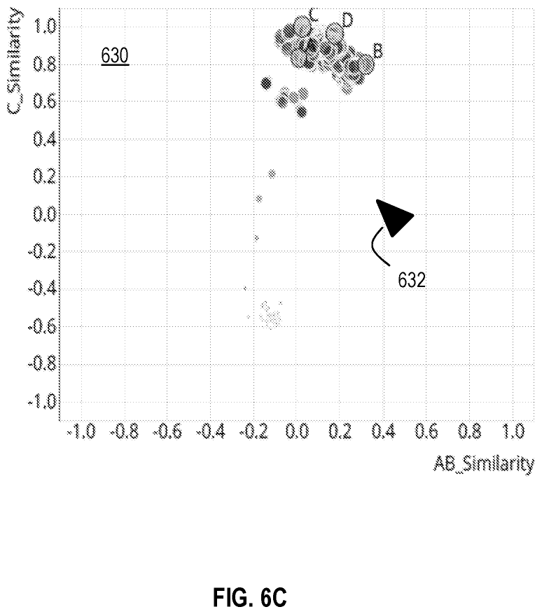

The difference between the targeted analogy and the result for a generic experiment is diagrammed in FIG. 6A. FIG. 6A is a block diagram that illustrates an example vector transform and enhancement for an analogy retrieval, according to an embodiment. In this example, the vector transform is a vector difference (V_{B}−V_{A}) as described in Equation 1 and the scaling factor is k=1. Vectors V_{A} and V_{B} are depicted as A and B, and the difference (V_{B}−V_{A}) as the line connecting the tip of A to the tip of B. The base query vector V_{C} is depicted as C, and the vector difference is added to its tip to produce dashed vector C+(B−A), which is equivalent to enhanced vector V_{Q}. The dotted vectors indicate the vectors E(t) of several documents in the videogame moments database at successive times t that are in the vicinity of V_{Q}. Of these, E(t_{D}) is closest to V_{Q} and selected as the vector V_{D} of output document D. V_{Q} is now more similar to the desired document vector V_{D} by angle than was the base query vector V_{C}. In this embodiment, the distance is selected as the cosine similar measure, which is related to the angle between vectors with small angles scoring the highest similarity”. Note that V_{D}=E(t_{D}) is not equivalent to V_{Q}, but is the closest vector in angle to V_{Q} among the vectors E(t) in the index at nearby times t.

In some embodiments, the user is given the option to select a different result than the one selected automatically, by being presented with the vector termination points for multiple query document query portions searched. FIG. 6B and FIG. 6C are plots that illustrate example GUI screens for user selection of analogy search results, according to various embodiments. In FIG. 6B, the interface includes graph 620 that plots all the vector tips on a horizontal (x) axis that indicates the similarly measure (e.g., dot product) for the difference between vectors V_{B} and V_{A} and a vertical (y) axis that indicates the similarity measure (e.g., dot product) between C and the candidate vector E, each plotted as a circle. The candidate vectors most analogous have the largest positive projection onto the line y=x. The vector tips having the best match are indicated by larger and filled circles. By moving cursor 622, a user can select any of the points, preferably one of the large solid filled circles. Similarly, in FIG. 6C, the interface includes graph 630 that plots all the vector tips on a horizontal axis that indicates the similarly measure (e.g., dot product) for the difference between vectors V_{B} and V_{A} and a vertical axis that indicates the similarity measure (e.g., dot product) between C and the candidate vector E, each plotted as a circle. The vector tips having the best match are indicated by larger and filled circles. By moving cursor 632, a user can select any of the points, preferably one of the large solid filled circles. Larger circles are labeled A, B, C and D to show where those vectors individually appear on this plot.

In general, it is advantageous to present the user with a two-dimensional array of candidate documents to select as the result of a search by analogy. For example, the search algorithm can be informed by this feedback of the most relevant results, as described below. In other embodiments, other measures of the similarity of V_{A} to V_{B} is on one axis and the similarity with V_{C} on the other axis. Applied in personalized search, the horizontal dimension could be how much the item matches the user's background references (independent of the current query item C). Rather than trying to tune how strong of an effect the personalization system should have, they user can examine the result chart themselves. If the personalization feature is clueless, they'll learn to ignore the horizontal position. If it is good, they'll learn to look at the top-right corner where the largest projection on the line y=x occurs. In some embodiments, the 2D search results are 2 forms of similarity to any search criteria, even searches that are not search by analogy, e.g. similarity to any two portions of a natural language search phrase.

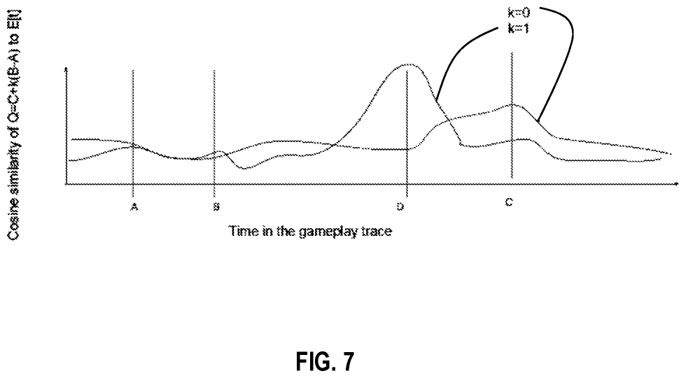

To evaluate how uniquely V_{D} is selected among the nearby vectors E(t), the cosine similarity is determined between V_{Q} and the vectors E(t). FIG. 7 is a plot that illustrates an example idealized trace of a similarity measure with moments in an interactive media stream with and without using an analogy vector transform, according to an embodiment. The horizontal axis indicates time during the game, corresponding to a succession of game moments, in arbitrary units. Moments A and B (M_{A} and M_{B}, respectively) associated with screenshot A and screenshot B occur before the moment C (M_{C}) of screenshot C. The vertical axis indicates cosine similarity to V_{Q}, in arbitrary units. Without using the analogy, i.e., with k=0 in this example, V_{Q}=V_{C} and the greatest similarity occurs, as expected, at M_{C} corresponding to screenshot C. Using the analogy, however, moment D (M_{D}), before M_{C}, has the greatest similarity to V_{Q}=V_{C}+(V_{B}−V_{A}). The similarity of moment D (M_{D}) is significantly increased while the similarity of moment C (M_{C}) is reduced. M_{D} would be ranked higher in search results than items similar to the base query C.

### 3.1 Moments in a Videogame Search

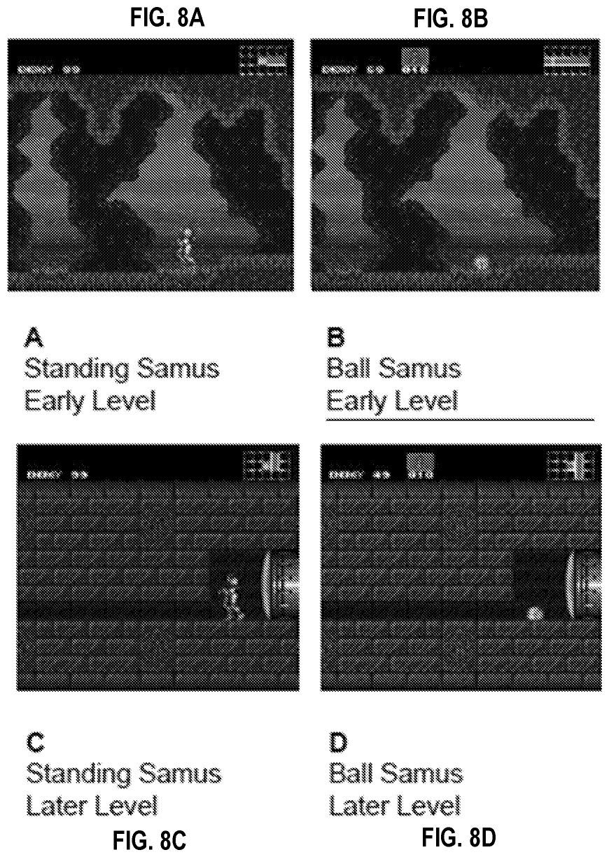

FIG. 8A through FIG. 8D are images that illustrate one example of analogy retrieval of moments in an interactive media stream, according to an embodiment. In this example, interactive media stream is a different videogame and the requestor is starting with a screenshot of a standing character at a later level of the game, represented by FIG. 8C. The analogy is represented by screenshots from two moments earlier in the game, represented by FIG. 8A with a standing character at an early level and FIG. 8B for the same level with a ball version of the character, and in the margins of the image a mini-map growth, missile gain, energy loss, and background/rain offset change. FIG. 8D shows a screenshot manually selected to demonstrate the analogy. Compared to FIG. 8C, the game moment of FIG. 8D shows the same level (good), ball character (good), mini-map growth (differently), missile gain, energy loss (different), tile set swap. These results better follow the analogy than the example of FIG. 5A through FIG. 5D.

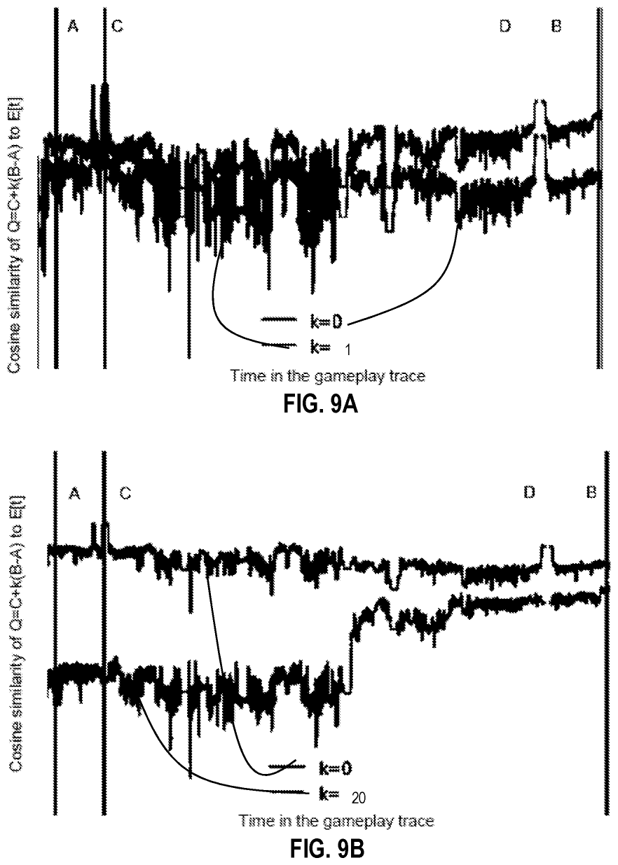

Given that in the experiments depicted in FIG. 5A through FIG. 5D, V_{C} was more similar to V_{Q} than any other E(t), the question is then asked whether there is some k such that similarity of V_{D} to V_{C}+k(V_{B}−V_{A}) is ever greater than similarity of V_{C} to V_{C}+k(V_{B}−V_{A})). FIG. 9A and FIG. 9B are plots that illustrate other example traces of a similarity measure with moments in an interactive media stream with and without using an analogy vector transform, according to an embodiment. These graphs drop everything before shot #1950 (cutscenes) and compare scaling factors k=0 to k=1. When the similarity of the k=1 trace exceeds the similarity of k=0 trace, then, yes, k=1 worked for the original ABCD set for FIG. 8A through FIG. 8B and seemed fine for k=0.5 to 10. In FIG. 9B, k=0 is compared to k=20. When the influence of the A-to-B transform is set sufficiently high (k=20), similarity to the base query C is effectively ignored and the retrieval system shows a preference for all those moments which possess the B-like nature (in the A-to-B distinction). The search by analogy method includes searching by distinction (represented by two items or item sets) as a special case.

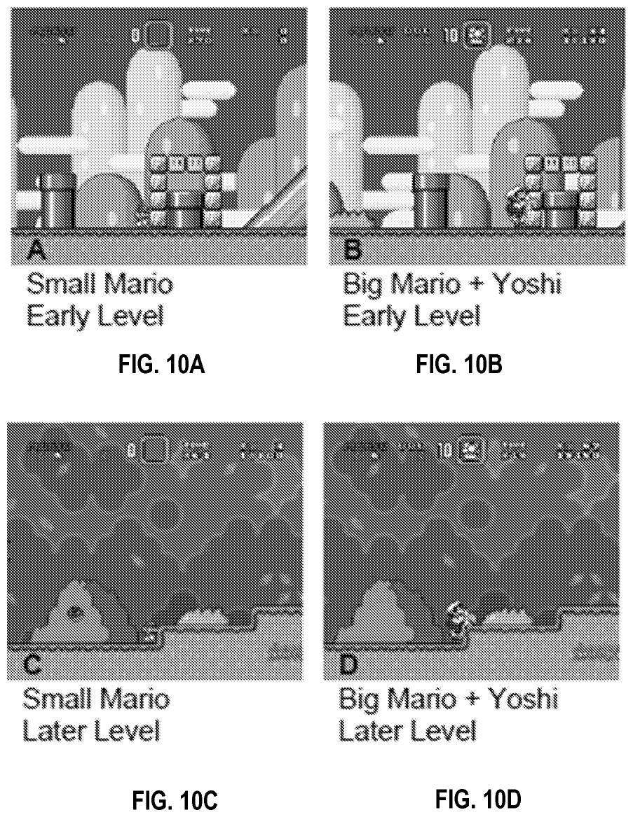

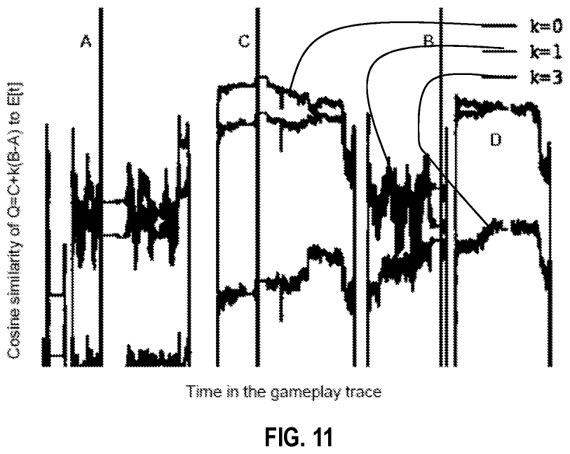

FIG. 10A through FIG. 10D are images that illustrate an example of analogy retrieval of moments in an interactive media stream, according to an embodiment. In this example, interactive media stream is a videogame and the requestor is starting with a screenshot of a small character at a later level of the game, represented by FIG. 10C. The analogy is represented by screenshots from two moments earlier in the game, represented by FIG. 10A with a small character at an early level and FIG. 10B for the same level with a larger version of the character and a second character (Yoshi), a mushroom, item gain, dragon coin gain, point gain, life gain, time loss. The transform is modeled by Equation 1 as a scaled translation. FIG. 10D was the manually selected version of a “correct” answer. Compared to FIG. 10C, the game moment of FIG. 5D shows the same level, larger character a second character (Yoshi), a. mushroom, item gain, dragon coin gain, point gain, life gain, time loss. This represents a very strong similarity to the analogy.

FIG. 11 is a plot that illustrates example traces of a similarity measure with moments in an interactive media stream using an analogy vector transform given by Equation 1 with various scale factors k, according to an embodiment. Here, k=1 worked to provide V_{D} with higher similarity to V_{Q} than V_{C} for the embodiment of FIG. 10A through FIG. 10D. For k=1 to k=3, the similarity of V_{D} to V_{Q} was higher than similarity of V_{C}. Note that the k=3 trace spikes at moment D even though this is not visible in the plot. For k higher than 4, the similarity of V_{B} scored higher than V_{D}.

### 3.2 Embedding Vectors Based on Neural Network

A more detailed embodiment for moments during play of videogames is described in this section, using neural networks to discover the embedding vectors. Recall that an embedding function maps a document (or a query) to a point in space. Good embeddings will place similar documents closer together in space and unrelated documents further apart. The estimated relevance of a document to a query can then be approximated by a distance calculation. Retrieval in this model reduces to a kind of nearest-neighbor lookup. In sophisticated web search engine designs, multiple layers of index-accelerated matching, filtering, ranking, and re-ranking systems are applied to compute a manageably small result set for the user to browse.

In this videogame domain embodiment, screenshot embedding neural networks are trained on a proxy task: reconstructing the contents of game platform memory from the embedding vector. Test data is obtained from BizHawk (found at domains tasvideos in superdomain org in file SNES.html in folder Bizhawk), which can emulate many different game platforms ranging from the Atari 2600 to the Nintendo 64 (based on a 32-bit processor connected to approximately 4 megabytes of working memory). As a result, this approach provides data volumes within reach of platforms similar to those targeted by the latest Android games.

Training deep neural networks for embedding images to vectors requires some indirection, when one does not have a dataset of the ideal vector representations. In an illustrated embodiment, a supervised learning task is set up in which good prediction performance is considered a proxy for good retrieval performance. In particular, it is asked that a relatively simple neural network be able to predict the contents of the first four kilobytes of memory for a given moment, given only the embedding of screenshot pixels as input. This very simple approach yields surprisingly good retrieval results.

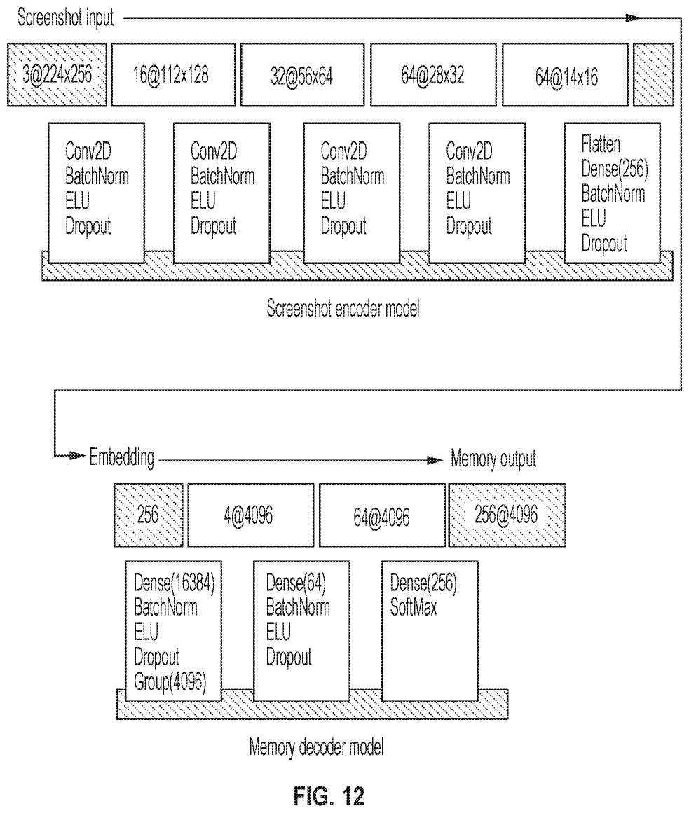

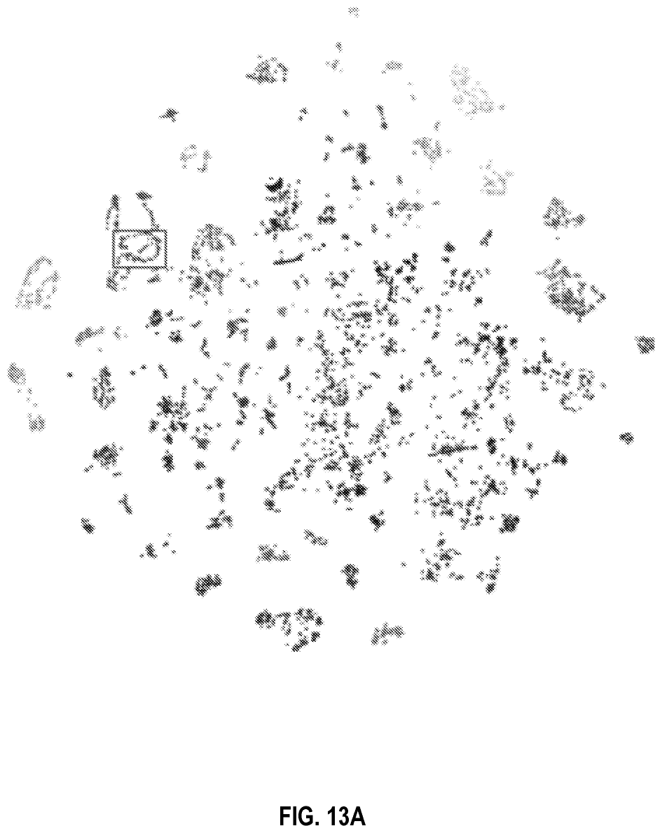

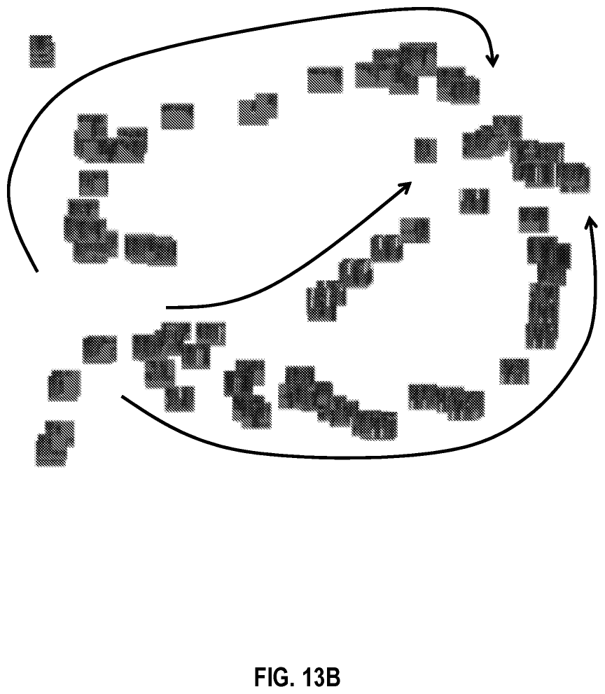

FIG. 12 is a block diagram that illustrates an example neural network used in the pixels-to-memory proxy task for generating embedding vectors, according to an embodiment. Embedding vectors are associated with the most narrow (“bottleneck”) layer of 256 nodes in this network. Despite being trained only as an intermediate representation on the proxy task, this moment vector representation manifests peculiar properties usually associated with learned word vector representation in natural language processing. In particular, the vectors manifest support for reasoning by analogy.

The top row illustrates data representations (by tensor shape) while the bottom row represents data transformations (by layer type). The input consists of an image of 224×256 pixels for each of three base colors. All two dimensional convolutional (Conv2D) layers apply 3×3 filter kernels in 2×2 stride convolution (that is the 4 pixels used in the convolution kernel are 2 pixels apart). Dropout layers replace 20% of outputs with zeros during training only to improve robustness. After training, the memory decoder model is discarded and the screenshot encoder model is kept for future use to output the 256 element embedding vector for each color input image of 224×256 pixels. These 256 values indicate the important information content of the image in terms of the program that produced the image, e.g., these 256 values provide the game context of the image.

Two sets of four images (varying in main character power-up state and location within a level) were used as moments to represent the analogy that A is to B as C is to D. Starting with the vector for moment C, one can add a scaled difference of vectors for B and A to get a vector as given by Equation 1, above. In both instances, Q is more similar (by the cosine similarity metric used for retrieval) to D than it is to the base image C or the others. A visual search engine user seeking moment D could search by vector-algebra analogy with screenshots A, B, and C. The parameter k controls the strength of the influence of the distinction between B and A.

In other embodiments, an approach to learning the embedding vector transform (an embedding model) considers manifold learning techniques that attempt to learn embedding models that smoothly map images of adjacent points in gameplay time to nearby points in space. Using a triplet loss model, the same embedding model is simultaneously applied to three images Q, A, and B (Q representing a query image while A and B represent potential retrieval results). A penalty term is added to the learning problem's optimization so that the cosine similarity between Q and A is higher than the cosine similarity between Q and B. For each moment Q in the training corpora, a moment A randomly sampled from within a few seconds of gameplay (in a speedrun) is paired with it, while B is randomly sampled from the rest of the corpus.

In still other embodiments, speedruns provide one more kind of data not used in the above techniques: control input data. This allows one to consider models where the inputs associated with a moment must be able to be reconstructed given the embedding of the current moment's screenshot image and the embedding from a moment a few seconds later. It is anticipated that control information may reveal useful visual structure related to play affordances.

In the following, unless otherwise specified, the embedding model is based on the neural network trained on the simple pixels-to-memory proxy task.

A typical method for visualizing data in high-dimensional spaces such as the embedding vectors is the t-distributed stochastic neighbor embedding (tSNE) algorithm. A tSNE visualization of three corpora is visible in FIG. 13A and FIG. 13B. FIG. 13A and FIG. 13B are scatter plot that illustrate an example tSNE visualization of embedding vectors, according to an embodiment. FIG. 13A visualize embedding vectors for approximately 10,000 moments from speedruns for Super Mario World, Super Metroid, and ActRaiser. One cluster of Mario moments is circled. FIG. 13B depicts the detail for the cluster of Mario moments where different paths (indicated by arrows) in a level are visible.

In this visualization, it is found that screenshots taken from the same room or level in the game tended to be part of the same cluster while structure within clusters sometimes echoed the structure of gameplay possibilities (such as when the player has multiple distinct routes to achieve a goal).

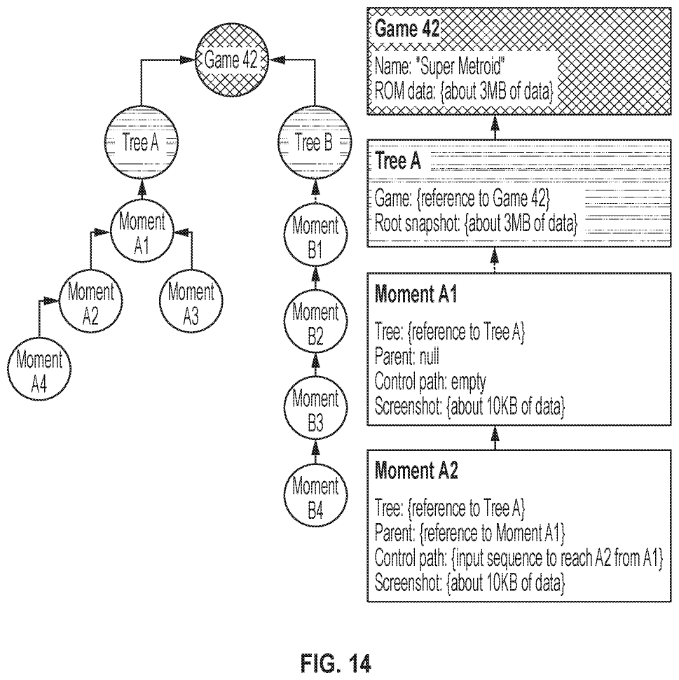

In an illustrated embodiment, data compression is used to store each moment of the corpus in the documents database 162. By exploiting the deterministic nature of a selected gaming emulator and the availability of control inputs used in a crawl through a gameplay, one can achieve significant compression of a corpus. FIG. 14 is a block diagram that illustrates an example of compressed tree representation, according to an embodiment. FIG. 14 depicts two moment trees for a single game. Tree A is a branchy tree as might result from an automatic exploration algorithm. Tree B is a linear chain tree as might result from playing back an expert speedrun input sequence.

In these embodiments, the full platform snapshot data is represented for just a single moment in the corpus. This is called the root state (and typically it is equivalent to the platform's clean boot state). All other moments are represented by the sequence of inputs needed to apply each frame to reach that state. An integer value from 0 to 4095 represents (in binary) the state of the primary controller's 12 buttons during that animation frame. If one thinks of a graph formed by the nodes discovered in various crawling approaches, that graph always forms a tree. From a given parent moment, just a few frames worth of input are applied over time to reach a child moment. Speedruns form long chains; and speedrun branches form spindly trees consisting of chain segments, and RRT produces very bushy trees in which some moments have very many children.

For a typical corpus (consisting of a few thousand moments), the amortized storage cost per moment is approximately one kilobyte. To facilitate visual inspection of a moment before trying to reconstruct the full platform state, a losslessly compressed (PNG) representation of the screen at the time of each moment is also stored. Because of repeating pixel patterns resulting from a SNES's sprite-driven graphics system used in some example embodiments, these images compress quite well (usually to low tens of kilobytes each).

After the user has selected a query image, e.g., from the user's own play, or published runs, or published images, among others, the same embedding model used to index the outcome of a crawl is applied to the query image. This will result in a query vector that lives in the same space as those used in the indexes. If the user selects multiple images to use as a query (or selects a video snippet from which one can sample a representative set of individual frames), one simple strategy is to average the vectors associated with each individual query image. Although it is expected that few users will search by memory state (they must have a platform snapshot in hand), it is still useful to think of memory embedding vectors as possible (components of) query vectors.

In some embodiments, all of the moments in a given corpus are ranked (or sorted) by their cosine similarity to a query. In other embodiments (such as the Maguro system in Microsoft's Bing search engine), multiple layers of re-ranking systems are applied to more carefully sort and prune successively smaller lists of documents by more and more complex criteria. Re-ranking is an excellent technique for addressing both scalability and search quality in Web-scale IR systems.

In some embodiments, a relevance feedback mechanism (e.g., based on the classic Rocchio algorithm) is implemented. In relevance feedback, users can browse the initial results of a search to mine positive and negative examples of relevant results (e.g., among the large filled circles chosen by a cursor in FIG. 6B and FIG. 6C.

In some embodiments, the user can re-submit the original query augmented with any number of positive and negative examples selected from the previous results. In the Rocchio algorithm (operating within the vector space retrieval model), a modified query vector is formed by a weighted average of the original query vector, the vectors associated with documents (moments) from the positive and negative example sets. Negative results are intuitively weighted negatively. This can be interpreted as exploiting vector analogies in the embedding space.

Because individual screenshots can be highly ambiguous, relevance feedback offers a way for the system to leverage its understanding of memory states. Imagine forming the vector representation of a moment by concatenating the 256-dimensional embedding of a screenshot with the 256-dimensional embedding of its memory state. In initial query vectors computed from user-submitted screenshots, one can fill in all-zero values for the memory components of this vector. However, upon tagging positive and negative examples from initial results, the Rocchio algorithm will produce a modified query vector with non-zero disambiguating values in the memory components of the vector. In a game like Super Metroid in which powerups a player has already collected are not easily discerned by inspecting an individual screenshot, this ability to reason about unobserved game state is advantageous.

In some embodiments, such as in a personalized shopping application, searching by analogy is used to tailor search results to specific users. Let A represent the collection of catalog items engaged with (e.g. clicked on) by the typical user of the shopping application. Let B represent the specific collection of items engaged with by a specific user. The distinction from A to B represents how this specific user's interests and tastes differ from the general population. Applying this distinction to this user's next query C defines a modified query D that takes this user's specific background behavior into account. Even when the user submits a query using only one term (C), the embodiment can extend their query by synthesizing collections A and B from that specific user's and other users' interaction with the application.

### 4. PROCESSING HARDWARE OVERVIEW

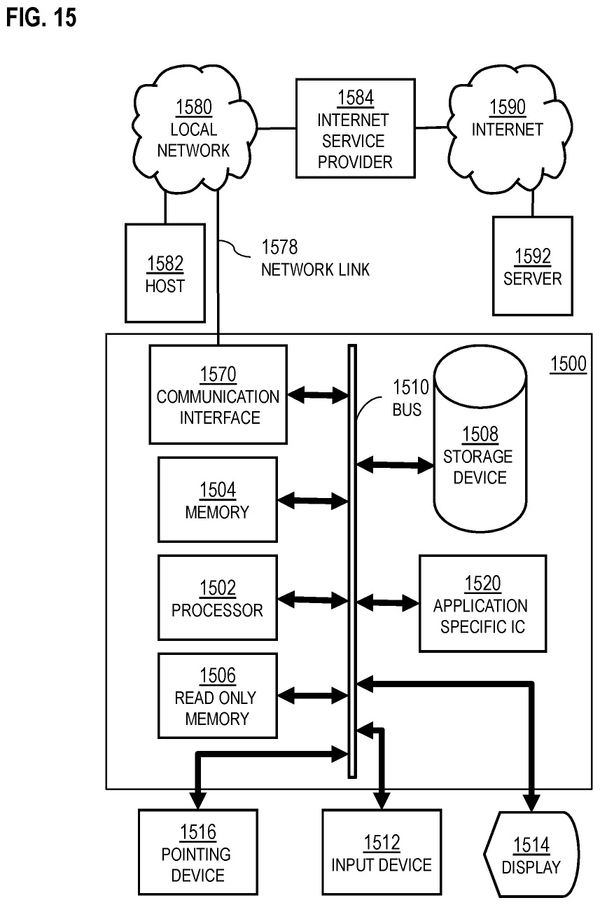

FIG. 15 is a block diagram that illustrates a computer system 1500 upon which an embodiment of the invention may be implemented. Computer system 1500 includes a communication mechanism such as a bus 1510 for passing information between other internal and external components of the computer system 1500. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1500, or a portion thereof, constitutes a means for performing one or more steps of one or more methods described herein.

A sequence of binary digits constitutes digital data that is used to represent a number or code for a character. A bus 1510 includes many parallel conductors of information so that information is transferred quickly among devices coupled to the bus 1510. One or more processors 1502 for processing information are coupled with the bus 1510. A processor 1502 performs a set of operations on information. The set of operations include bringing information in from the bus 1510 and placing information on the bus 1510. The set of operations also typically include comparing two or more units of information, shifting positions of units of information, and combining two or more units of information, such as by addition or multiplication. A sequence of operations to be executed by the processor 1502 constitutes computer instructions.

Computer system 1500 also includes a memory 1504 coupled to bus 1510. The memory 1504, such as a random access memory (RAM) or other dynamic storage device, stores information including computer instructions. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of computer instructions. The computer system 1500 also includes a read only memory (ROM) 1506 or other static storage device coupled to the bus 1510 for storing static information, including instructions, that is not changed by the computer system 1500. Also coupled to bus 1510 is a non-volatile (persistent) storage device 1508, such as a magnetic disk or optical disk, for storing information, including instructions, that persists even when the computer system 1500 is turned off or otherwise loses power.

Information, including instructions, is provided to the bus 1510 for use by the processor from an external input device 1512, such as a keyboard containing alphanumeric keys operated by a human user, or a sensor. A sensor detects conditions in its vicinity and transforms those detections into signals compatible with the signals used to represent information in computer system 1500. Other external devices coupled to bus 1510, used primarily for interacting with humans, include a display device 1514, such as a cathode ray tube (CRT) or a liquid crystal display (LCD), for presenting images, and a pointing device 1516, such as a mouse or a trackball or cursor direction keys, for controlling a position of a small cursor image presented on the display 1514 and issuing commands associated with graphical elements presented on the display 1514.

In the illustrated embodiment, special purpose hardware, such as an application specific integrated circuit (IC) 1520, is coupled to bus 1510. The special purpose hardware is configured to perform operations not performed by processor 1502 quickly enough for special purposes. Examples of application specific ICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a two-way communication coupling to a variety of external devices that operate with their own processors, such as printers, scanners and external disks. In general the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 1570 sends and receives electrical, acoustic or electromagnetic signals, including infrared and optical signals, that carry information streams, such as digital data.

The term computer-readable medium is used herein to refer to any medium that participates in providing information to processor 1502, including instructions for execution. Such a medium may take many forms, including, but not limited to, non-volatile media, volatile media and transmission media. Non-volatile media include, for example, optical or magnetic disks, such as storage device 1508. Volatile media include, for example, dynamic memory 1504. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 1502, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 1502, except for carrier waves and other signals.

Logic encoded in one or more tangible media includes one or both of processor instructions on a computer-readable storage media and special purpose hardware, such as ASIC 1520.

Network link 1578 typically provides information communication through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590. A computer called a server 1592 connected to the Internet provides a service in response to information received over the Internet. For example, server 1592 provides information representing video data for presentation at display 1514.

The invention is related to the use of computer system 1500 for implementing the techniques described herein. According to one embodiment of the invention, those techniques are performed by computer system 1500 in response to processor 1502 executing one or more sequences of one or more instructions contained in memory 1504. Such instructions, also called software and program code, may be read into memory 1504 from another computer-readable medium such as storage device 1508. Execution of the sequences of instructions contained in memory 1504 causes processor 1502 to perform the method steps described herein. In alternative embodiments, hardware, such as application specific integrated circuit 1520, may be used in place of or in combination with software to implement the invention. Thus, embodiments of the invention are not limited to any specific combination of hardware and software.

The signals transmitted over network link 1578 and other networks through communications interface 1570, carry information to and from computer system 1500. Computer system 1500 can send and receive information, including program code, through the networks 1580, 1590 among others, through network link 1578 and communications interface 1570. In an example using the Internet 1590, a server 1592 transmits program code for a particular application, requested by a message sent from computer 1500, through Internet 1590, ISP equipment 1584, local network 1580 and communications interface 1570. The received code may be executed by processor 1502 as it is received, or may be stored in storage device 1508 or other non-volatile storage for later execution, or both. In this manner, computer system 1500 may obtain application program code in the form of a signal on a carrier wave.

Various forms of computer readable media may be involved in carrying one or more sequence of instructions or data or both to processor 1502 for execution. For example, instructions and data may initially be carried on a magnetic disk of a remote computer such as host 1582. The remote computer loads the instructions and data into its dynamic memory and sends the instructions and data over a telephone line using a modem. A modem local to the computer system 1500 receives the instructions and data on a telephone line and uses an infra-red transmitter to convert the instructions and data to a signal on an infra-red a carrier wave serving as the network link 1578. An infrared detector serving as communications interface 1570 receives the instructions and data carried in the infrared signal and places information representing the instructions and data onto bus 1510. Bus 1510 carries the information to memory 1504 from which processor 1502 retrieves and executes the instructions using some of the data sent with the instructions. The instructions and data received in memory 1504 may optionally be stored on storage device 1508, either before or after execution by the processor 1502.

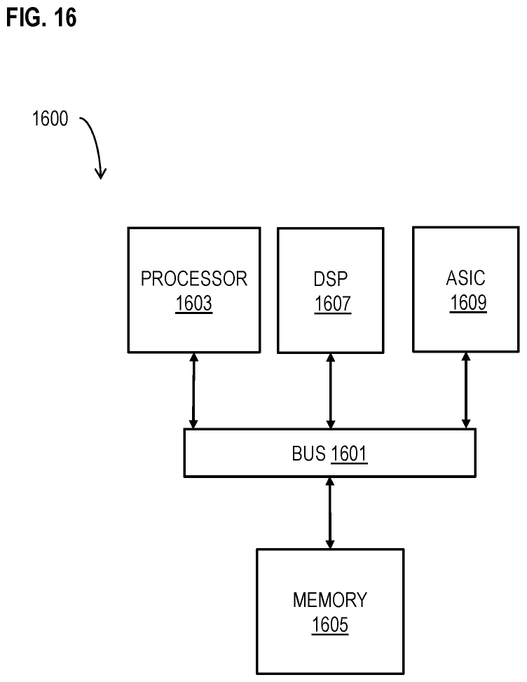

FIG. 16 illustrates a chip set 1600 upon which an embodiment of the invention may be implemented. Chip set 1600 is programmed to perform one or more steps of a method described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1600, or a portion thereof, constitutes a means for performing one or more steps of a method described herein.

In one embodiment, the chip set 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 1605 also stores the data associated with or generated by the execution of one or more steps of the methods described herein.

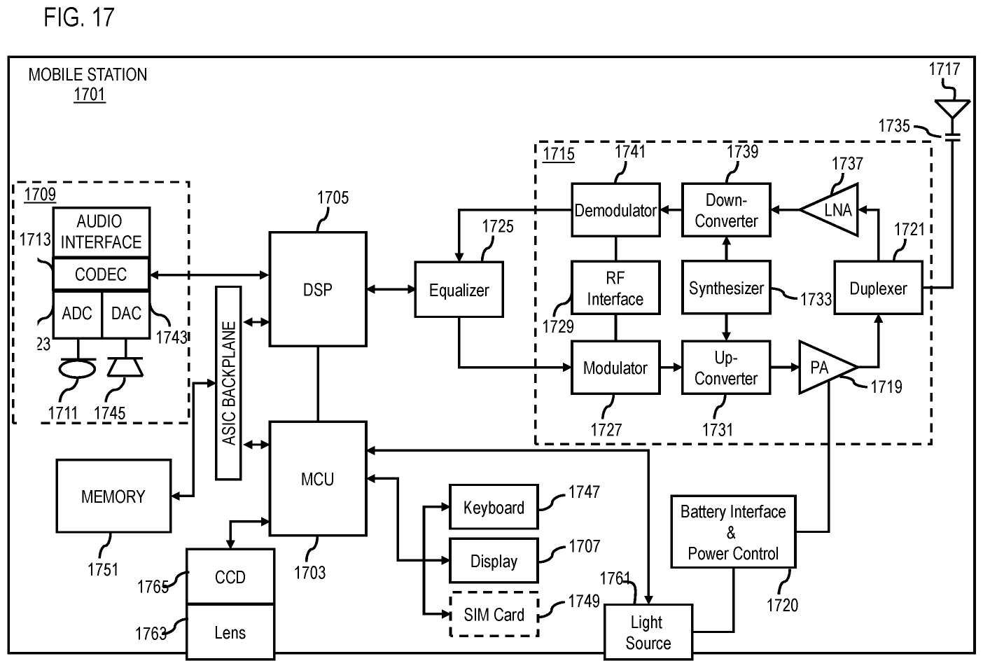

FIG. 17 is a diagram of exemplary components of a mobile terminal 1700 (e.g., cell phone handset) for communications, which is capable of operating in the system, according to one embodiment. In some embodiments, mobile terminal 1701, or a portion thereof, constitutes a means for performing one or more steps described herein. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile terminal functions that perform or support the steps as described herein. The display 1707 includes display circuitry configured to display at least a portion of a user interface of the mobile terminal (e.g., mobile telephone). Additionally, the display 1707 and display circuitry are configured to facilitate user control of at least some functions of the mobile terminal. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile terminal 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1725 for compensation of any frequency-dependent impairments that occur during transmission though the air such as phase and amplitude distortion. After equalizing the bit stream, the modulator 1727 combines the signal with a RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703 which can be implemented as a Central Processing Unit (CPU) (not shown).

The MCU 1703 receives various signals including input signals from the keyboard 1747. The keyboard 1747 and/or the MCU 1703 in combination with other user input components (e.g., the microphone 1711) comprise a user interface circuitry for managing user input. The MCU 1703 runs a user interface software to facilitate user control of at least some functions of the mobile terminal 1701 as described herein. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the terminal. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile terminal 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable storage medium known in the art. The memory device 1751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1749 carries, for instance, important information, such as the cellular phone number, the carrier supplying service, subscription details, and security information. The SIM card 1749 serves primarily to identify the mobile terminal 1701 on a radio network. The card 1749 also contains a memory for storing a personal telephone number registry, text messages, and user specific mobile terminal settings.

In some embodiments, the mobile terminal 1701 includes a digital camera comprising an array of optical detectors, such as charge coupled device (CCD) array 1765. The output of the array is image data that is transferred to the MCU for further processing or storage in the memory 1751 or both. In the illustrated embodiment, the light impinges on the optical array through a lens 1763, such as a pin-hole lens or a material lens made of an optical grade glass or plastic material. In the illustrated embodiment, the mobile terminal 1701 includes a light source 1761, such as a LED to illuminate a subject for capture by the optical array, e.g., CCD 1765. The light source is powered by the battery interface and power control module 1720 and controlled by the MCU 1703 based on instructions stored or loaded into the MCU 1703.

### 5. ALTERNATIVES, DEVIATIONS AND MODIFICATIONS

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

### 6. REFERENCES

Each of the references cited are hereby incorporated by reference as if fully set forth herein, except for terminology inconsistent with that used herein.
Aaron Bauer and Zoran Popovic. 2012. RRT-Based Game Level Analysis, Visu-alization, and Visual Refinement. In Proc. of the AAAI Conference on Artificial Intelligence in Interactive Digital Entertainment.
Sean Bell and Kavita Bala. 2015. Learning visual similarity for product design with convolutional neural networks. ACM Transactions on Graphics (TOG) 34, 4 (2015), 98.
Marc Bellemare, Sriram Srinivasan, Georg Ostrovski, Tom Schaul, David Sax-ton, and Remi Munos. 2016. Unifying count-based exploration and intrinsic motivation. In Advances in Neural Information Processing Systems. 1471-1479.
Vijay Chandrasekhar, Matt Sharifi, and David A Ross. 2011. Survey and Evaluation of Audio Fingerprinting Schemes for Mobile Query-by-Example Applications. In ISMIR, Vol. 20. 801-806.
W Bruce Croft, Donald Metzler, and Trevor Strohman. 2010. Search engines: Information retrieval in practice. Vol. 283. Addison-Wesley Reading.
Gregory Finley, Stephanie Farmer, and Serguei Pakhomov. 2017. What analogies reveal about word vectors and their compositionality. In Proceedings of the 6th Joint Conference on Lexical and Computational Semantics (* SEM 2017). 1-11.
Jeff Johnson, Matthijs Douze, and Hervé Jégou. 2017. Billion-scale similarity search with GPUs. arXiv preprint arXiv:1702.08734 (2017).
Karen Sparck Jones. 1999. Information retrieval and artificial intelligence. Artifi-cial Intelligence 114, 1-2 (1999), 257-281.
Eric Kaltman, Joseph Osborn, Noah Wardrip-Fruin, and Michael Mateas. 2017. Game and Interactive Software Scholarship Toolkit (GISST). (2017).
John Koetsier. 2013. How Google searches 30 trillion web pages, 100 billion times a month. Venture Beat (March 2013). Domain venturebeat at super-domain com in folder 2013 subfolder 03 subfolder 01 file how-google-searches-30-trillion-web-pages-100-billion-times-a-month.
Steven M LaValle. 1998. Rapidly-exploring random trees: A new tool for path planning. (1998).
Laurens van der Maaten and Geoffrey Hinton. 2008. Visualizing data using t-SNE. Journal of machine learning research 9, November (2008), 2579-2605.
Christopher D. Manning, Prabhakar Raghavan, and Hinrich Schütze. 2008. Introduction to Information Retrieval. Cambridge University Press, New York, N.Y., USA.
Volodymyr Mnih, Koray Kavukcuoglu, David Silver, Andrei A Rusu, Joel Veness, Marc G Bellemare, Alex Graves, Martin Riedmiller, Andreas K Fidjeland, Georg Ostrovski, et al. 2015. Human-level control through deep reinforcement learning. Nature 518, 7540 (2015), 529.
Mark J Nelson. 2011. Game Metrics Without Players: Strategies for Understanding Game Artifacts. In Artificial Intelligence in the Game Design Process.
Joseph Osborn, Adam Summerville, and Michael Mateas. 2017. Automatic map-ping of NES games with mappy. In Proceedings of the 12th International Conference on the Foundations of Digital Games. ACM, 78.
Knut Magne Risvik, Trishul Chilimbi, Henry Tan, Karthik Kalyanaraman, and Chris Anderson. 2013. Maguro, a system for indexing and searching over very large text collections. In Proceedings of the sixth ACM international conference on Web search and data mining. ACM, 727-736.
Joseph John Rocchio. 1971. Relevance feedback in information retrieval. The SMART retrieval system: experiments in automatic document processing (1971), 313-323.
Linda C Smith. 1976. Artificial intelligence in information retrieval systems. Information Processing & Management 12, 3 (1976), 189-222.
James Somers. 2017. Torching the Modern-Day Library of Alexandria. The Atlantic (April 2017). In domain theatlantic super-domain com folder technology subfolder archive subfolder 2017 subfolder 04 subfolder the-tragedy-of-google-books file 523320.
Julian Togelius, Noor Shaker, Sergey Karakovskiy, and Georgios N Yannakakis. 2013. The mario ai championship 2009-2012. AI Magazine 34, 3 (2013), 89-92.
Zeping Zhan and Adam M Smith. 2015. Retrieving Game States with Moment Vectors. (2015).

What is claimed is:

1. A method for retrieval of a document, comprising:
storing in an index for each document from an archived set of documents, a vector of dimension N, wherein the vector is based on a query portion of the document according to a particular algorithm;
receiving, from a requester, an analogy query that indicates a query portion A based on a first set of one or more documents and a query portion B based on a second set of one or more documents and a query portion C of a third set of one or more documents, such that each of one or more retrieved documents D has a query portion D that is related to query portion C as query portion B is related to query portion A;
determining a vector A based on the query portion A and the particular algorithm, a vector B based on the query portion B and the particular algorithm, and a vector C based on the query portion C and the particular algorithm;
determining a transform from vector A to vector B;
forming an enhanced vector Q based on the vector C and the transform from vector A to vector B; and
presenting, to the requester, at least a reference to, or a portion of, each of the one or more retrieved documents D from the archived set of documents based on proximity of a vector of each of the one or more retrieved documents D in the index to the enhanced vector Q.

2. The method as recited in claim 1, wherein the query portion is the document in its entirety.

3. The method as recited in claim 1, wherein the query portion is a screenshot from a multimedia document.

4. The method as recited in claim 1, wherein the document is a moment of an interactive media stream that includes a screenshot and an image of a memory state and a time stamp.

5. The method as recited in claim 1, wherein the transform is a vector difference subtracting vector A from vector B.

6. The method as recited in claim 5, wherein the enhanced vector is a sum of the vector C with the vector difference scaled by a factor k.

7. The method as recited in claim 6, wherein the factor k is in a range from about 1 to about 4.

8. The method as recited in claim 1, wherein the transform is a rotation.

9. The method as recited in claim 1, wherein the particular algorithm is a deep trained neural network predictive of the whole document.

10. The method as recited in claim 1, wherein the particular algorithm is a principal component decomposition.

11. A non-transitory computer-readable medium carrying one or more sequences of instructions, wherein execution of the one or more sequences of instructions by one or more processors causes the one or more processors to perform one or more steps of the method of claim 1.

12. An apparatus comprising:
at least one processor; and
at least one memory including one or more sequences of instructions,
the at least one memory and the one or more sequences of instructions configured to, with the at least one processor, cause the apparatus to perform one or more steps of the method of claim 1.

13. A method implemented on a processor for retrieval of a document, comprising:
storing an archived set of documents;
receiving, from a requester, a query;
based on the query identifying a plurality of retrieved documents D from the archived set of documents;
presenting, to the requester, at least a reference to, or a portion of, each of the plurality of retrieved documents D on a two-dimension plot wherein a first dimension of the two dimensional plot indicates similarity to a first portion of the query and a second dimension of the two dimensional plot indicates similarity to a different second portion of the query.

14. A non-transitory computer-readable medium carrying one or more sequences of instructions, wherein execution of the one or more sequences of instructions by one or more processors causes the one or more processors to perform one or more steps of the method of claim 13.

15. An apparatus comprising:
at least one processor; and
at least one memory including one or more sequences of instructions,
the at least one memory and the one or more sequences of instructions configured to, with the at least one processor, cause the apparatus to perform one or more steps of the method of claim 13.
